(19) United States
(12) Patent Application Publication
(10) Pub. No.: US 2006/0075326 A1
(43) Pub. Date: Apr. 6, 2006

(54) Research software tool with flowchart graphic user interface

(76) Inventors: Parag Patel, Marina Del Rey, CA (US); Alok K. Gupta, Venice, CA (US); Claudia Anne Carver, Los Angeles, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/945,455

(22) Filed: Sep. 20, 2004

(51) Int. Cl. G06F 17/24

(52) U.S. Cl. 715/501.1

(57) ABSTRACT

A research software tool for use with an online external resource. The research software tool includes a flowchart graphic user interface. The flowchart graphic user interface includes a graphically indicated first defined area, and a text string displayable within the first defined area. The flowchart graphic user interface further includes a graphically indicated second defined area, and a text string displayable within the second defined area. At least one of the text strings is user selectable. The flowchart graphic user interface further includes relationship symbology displayable between the first and second defined areas. The research software tool further includes a user selectable link corresponding to the at least one of the text strings. The user selectable link is configured to interface with the online external resource.

### BACKGROUND OF THE INVENTION

1. Field of the Invention

The present invention relates generally to research software tool, and in particular to a research software tool including a flowchart graphic user interface with a text string and an associated user selectable link.

2. Description of the Prior Art

Through the use of complex computer networks, such as the Internet, researchers have access to a vast amount of resources virtually at their fingertips. However, efficiently navigating to such online resources is a topic of concern.

Such online resources, also referred to as knowledge stores, usually take the form of computer servers containing databases. These online resources may be operated by private, charitable and governmental entities. Access to the online resources is typically through an associated website. The online resources may be freely accessed or are proprietary in nature requiring a fee.

In the case of legal research for example, a research attorney may consult a treatise on a given topic or issue of concern, such as the rules of civil procedure. Such a treatise may be in hardcopy or an electronic version. Using the treatise, the researcher would begin with a visual scan or browse the many pages of a table of contents or index at the back of the treatise. Through trial and error the researcher would have to consult the referenced portions of the treatise until he/she has found issue relevant content or text. Often such relevant content or text would provide cross references to other resources. In the case of legal research, citations may be made to a legal case law opinion, a governmental or non-governmental agency no-action or opinion letter or memorandum, a portion of a statute or regulation, or to a portion of another treatise for example. Where the treatise is electronic form, such citations may be active links or hyperlinks to such citations. Such links may connect to content that is hosted by an online resource that may or may not be operated by the same operator that maintains the electronic version of the treatise being used. These links may include a highlighted text string that can be selected by the user (such as by clicking with a mouse) and configured to link with a specific web page or computer file.

Another typical online research approach would be to locate and access content that is hosted on online resources using a “search engine.” A search engine is a computer program that receives key words as user inputs and performs an online search of various online resources to locate content related to the inputted key words. A key word search is typically Boolean search that utilizes key words (also referred to as parameters or search terms). The matched content may reside in databases maintained by the search engine operator itself or may reside externally as hosted by some other online resource. The efficiency of the key word searching is highly dependent upon the user inputting the appropriate “key words.”

Another online research approach would be to search in specific known databases. Such databases may reside at online resources that are freely accessed or proprietary in nature requiring a fee (e.g., LEXIS/NEXIS or WESTLAW). These online resources may facilitate their content to be located through a key word search in one or more of several topical hierarchically-organized databases (e.g. “ALLFEDS” in the WESTLAW databases) or through a proprietary classification system (e.g. “keynotes” in the WESTLAW databases or “more like this” in the LEXIS/NEXUS databases). Again, the efficiency of the key word searching is highly dependent upon the user inputting the appropriate “key words.”

The above-referenced prior art research techniques require the use of referencing a table of contents, indexes, proprietary classification systems and/or key words to arrive at the user's desired search results. Such prior art techniques also fail to provide intuitive visually-orientated formats or user interfaces for initiating and optimizing the user's search.

Accordingly, there is a need in the art for an improved system for facilitating online research in comparison to the prior art.

### SUMMARY OF THE INVENTION

An aspect of the present invention can be regarded as a research software tool for use with an online external resource. The research software tool includes a flowchart graphic user interface. The flowchart graphic user interface includes a graphically indicated first defined area, and a text string displayable within the first defined area. The flowchart graphic user interface further includes a graphically indicated second defined area, and a text string displayable within the second defined area. At least one of the text strings is user selectable. The flowchart graphic user interface further includes relationship symbology displayable between the first and second defined areas. The research software tool further includes a user selectable link corresponding to the at least one of the text strings. The user selectable link is configured to interface with the online external resource. Advantageously, it is contemplated that an end user of the research software tool is enabled to navigate to content contained in the online external resource in a visually intuitive manner as navigation is guided in the context of a flowchart format.

According to various embodiments, the at least one of the text strings may be clickable. The user selectable link may be an active link for electronically linking with the online external resource. Alternatively, the user selectable link may be a passive link for electronically linking with the online external resource. The user selectable link may include predefined search criteria for use with the online external resource. In this regard, the user selectable link may include pre-loaded search terms for use in retrieving content contained in the external resource. The at least one of the text strings may be the user selectable link. In another embodiment, the at least one of the text strings includes a displayable menu, and the menu includes the user selectable link. The user selectable link may be configured to interface with a plurality of online external resources. The user selectable link may be configured to interface with the online external resources via the Internet.

### BRIEF DESCRIPTION OF THE DRAWINGS

FIG. 1 is a symbolic plan view of a research software tool as shown in functional relation to an end user and online external resources in accordance with the present invention;

FIG. 2 is a plan view of a computer monitor displaying an illustrative flowchart graphic user interface and display window;

FIG. 3 is a enlarged view of a graphically indicated area of the display window of the flowchart graphic user interface of FIG. 2; and

FIG. 4 is the graphically indicated area of FIG. 3 as additionally shown with a pop-up window.

### DESCRIPTION OF THE PREFERRED EMBODIMENTS

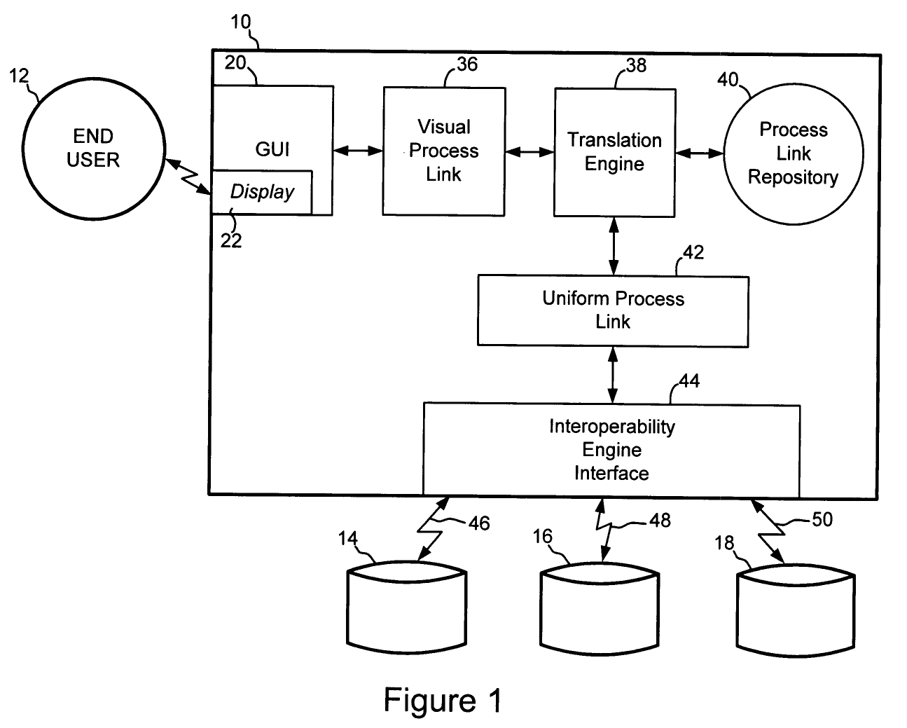

Referring now to the drawings wherein the showings are for purposes of illustrating preferred embodiments of the present invention only, and not for purposes of limiting the same, FIGS. 1-4 illustrate a research software tool in accordance with the aspects of the present invention.

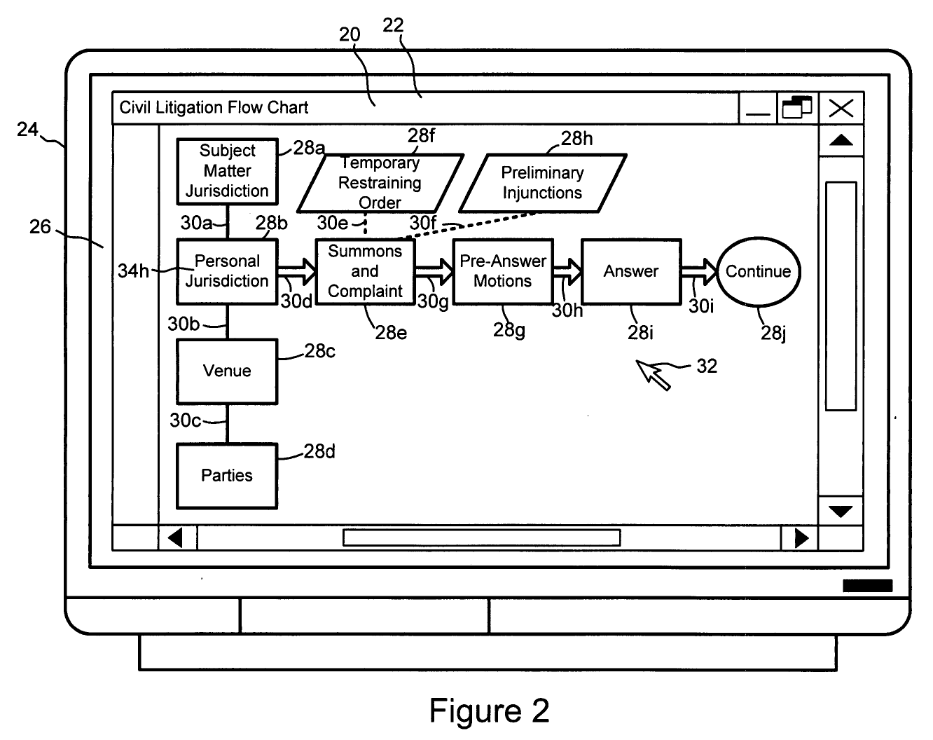

Referring now to FIG. 1, there is depicted a symbolic plan view of a research software tool 10 as shown in functional relation to an end user 12 and online external resources 14, 16, 18 in accordance with the present invention. The research software tool 10 includes a flowchart graphic user interface 20 including a display 22. In this regard, FIG. 2 depicts a plan view of a computer monitor 24. The computer monitor 24 includes a display field 26. In this particular embodiment, the flowchart graphic user interface 20 including its display 22 appears in the display field 26. Though not required, the display 22 takes the form of a “window” in this particular embodiment.

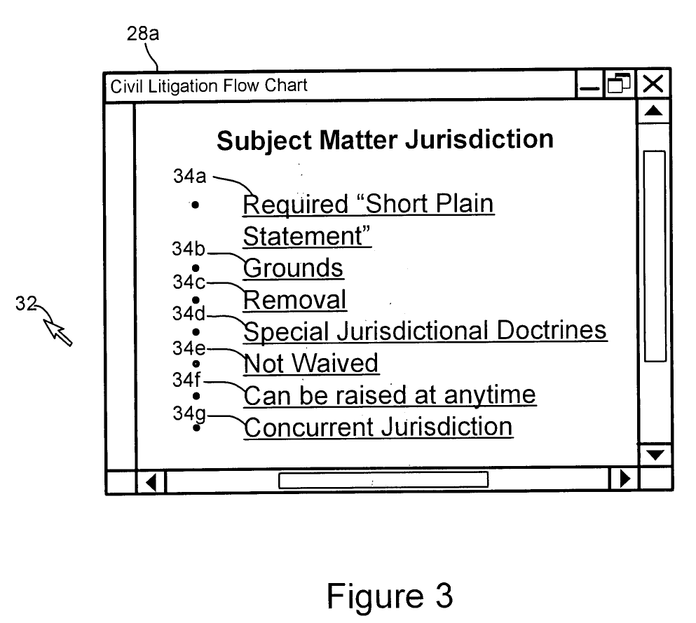

The flowchart graphic user interface 20 of this embodiment includes graphically indicated defined areas 28a-j. An enlarged view of the graphically indicated defined area 28a is shown in FIG. 3. In this regard, details of contents of each of the graphically indicated defined areas 28a-j are not shown in FIG. 2 for ease of illustration. The flowchart graphic user interface 20 of this embodiment further includes relationship symbology 30a-i interposed between various ones of the graphically indicated defined areas 28a-j. As seen in FIG. 3, the graphically indicated defined area 28a includes text strings 34a-h. In this example, the flowchart graphic user interface 20 is related to the topic of civil litigation.

An aspect of the present invention can be regarded as the research software tool 10 for use with an online external resource, such as the online external resource 14. The research software tool 10 includes the flowchart graphic user interface 20. The flowchart graphic user interface 20 includes a graphically indicated first defined area (such as graphically indicated defined area 28a) and a text string (such as text string 34b) displayable within the graphically indicated defined area 28a. The flowchart graphic user interface 20 further includes a graphically indicated second defined area (such as graphically indicated defined area 28b), and a text string (such as text string 34h) displayable within the graphically indicated defined area 28b. At least one of the text strings 34b, 34h is user selectable. The flowchart graphic user interface 20 further includes relationship symbology (such as relationship symbology 30a) displayable between the graphically indicated defined areas 28a-b. The research software tool 10 further includes a user selectable link 46 corresponding to the at least one of the text strings, such as text string 34b. The user selectable link 46 is configured to interface with the online external resource 14.

Being a “flowchart” the flowchart graphic user interface 20 is intended to provide the end user 12 with a visual organization of data, including relationships between various items of data (such as chronological, sequential or organizational relationships). These may be temporal as well as event based. As mentioned above, in this example the flowchart graphic user interface 20 is related to the topic of civil litigation, and would be intended to be helpful to an end user 12 who is a litigator. The flowchart graphic user interface 20 presents data related to the process of civil litigation. In this regard, by quickly scanning the flowchart graphic user interface 20 the end user 20 is contemplated to understand that the issues related to “subject matter,” “personal jurisdiction”, “venue,” and “parties” (as indicated in the defined areas 28a-d) all must be addressed prior to completion of the issue of “summons and complaint” (as indicated in the defined area 28e). Furthermore, the portion of the litigation process associated with the “summons and complaint” must be completed prior to moving on to the topic of “pre-answer motions” (as indicated in the defined area 28g).

The relative positioning of the various ones of the graphically indicated defined areas 28a-j upon the display 22 aid in the understanding of the end user 12 of the various relationships. In addition, the relationship symbology further conveys information to the end user 12 regarding the relationship between the graphically indicated defined areas 28a-j. The relative locations of the defined areas 28a-d, 28e and the relationship symbology 20a-d are intended to convey to the end user 12 that the issues associated with the defined areas 28a-d are addressed prior to those issues of the defined area 28e.

The topical scope of the flowchart graphic user interface 20 may be unlimited. The example shown is related to civil procedure. Other sample topics or processes that lend themselves to presentation in a flowchart format may include, but are not limited to, specific issues in civil litigation such as discovery; evidence; criminal procedure; wage and labor law; constitutional law; appellate law; class actions; specific types of litigation (such a sexual and/or racial harassment lawsuits); contracting; corporate formation; mergers and acquisitions; securing protection of intellectual property; initial public offerings; private offerings; real estate purchase and sale agreements; buying and/or selling a home; basic home repair; traveling in a particular city or country; personal income taxes; trading stocks and other securities; developing photographs; buying and/or selling a franchise; schematics of the world's religions; asset allocation strategies; schematic of a space shuttle launch; diagnoses of a disease based on symptoms; fixing a television; adding memory to a personal computer or laptop; tune-up procedures for a vehicle; and specific vehicle repairs.

As mentioned above, the research software tool 10 includes the user selectable link 46 corresponding to the at least one of the text strings, such as text string 34b, and the user selectable link 46 is configured to interface with the online external resource 14. In this regard, the research software tool 10 is contemplated to facilitate ready access by the end user 12 to content contained in the online external resource 14. It is contemplated that the end user 12 is enabled to navigate to such external content in a visually intuitive manner as navigation is guided in the context of a flowchart format. When performing a research task, the flow chart presentation of the various defined areas 28a-j efficiently allows the end user 12 to locate external content associated with a given defined area 28a-j. This is in contrast to accessing results (e.g. case opinions, statutes, and relevant sections of secondary materials in the context of a civil litigation flowchart) through a typical chapter/page presentation such as in the case of an electronic version of a treatise on the topic of interest. The end user 12 does not need to analyze any table of contents or index. This is also in contrast to accessing results through key word searching where the end user 12 is required to identify the appropriate key words. Further, it is contemplated that the flowchart presentation allows the end user 12 to identify issues quickly because the end user 12 is allowed to see the overall context in which the issues are being presented.

In further detail, the graphically indicated defined areas 28a-j may take a variety of forms. In the example shown, the defined areas 28a-d, 28e, 28g, 28i are indicated by solid lined rectangles, the defined areas 28f, 28h are indicated by solid lined trapezoids, and the defined area 28j is indicated with a solid lined oval. Other shapes may be utilized. Although the perimeter lining is shown as being black solid lined, any other lining may be utilized such as dotted or dashed, as well as various line thicknesses and colors (including clear). The defined areas 28a-j are shown with a clear background. However, the background coloring, pattern and shading also may be varied. The various forms of the defined areas 28a-j may be used to provide the end user 12 with information which may be spelled out in a legend for example. For example, trapezoid shapes may used to indicate optional items, such as indicated by the defined areas 28f, 28h. The relationship symbology 30a-i may also be indicated in a variety of ways, including variances of shape, lining, background and/or color.

Preferably the user 12 is allowed to interact with the graphically indicated defined areas 28a-j through controlled usage of a cursor 32. The cursor 32 may be moved to various portions of the display 22. For example, FIG. 3 depicts the graphically indicated defined area 28a with its associated text strings 34a-g (it is noted that FIG. 2 does not include the detail of the text strings 34a-g of the defined areas 28a for ease of illustration). The defined area 28a is related to the topic of “subject matter.” The end user 12 may move the cursor 32 to a selected one of the text strings 34a-g.

According to various embodiments, the at least one of the text strings 34a-h may be clickable. Thus, selected ones of the text strings 34a-h may be associated with a user selectable link 42. The text string 34a may be selected by navigating the cursor over the text string 34a and clicking on it. This may initiate the establishment of the user selectable link 42 which may be configured to link with the online external resource 14. In the embodiment shown, the user selectable link 42 is a uniform process link.

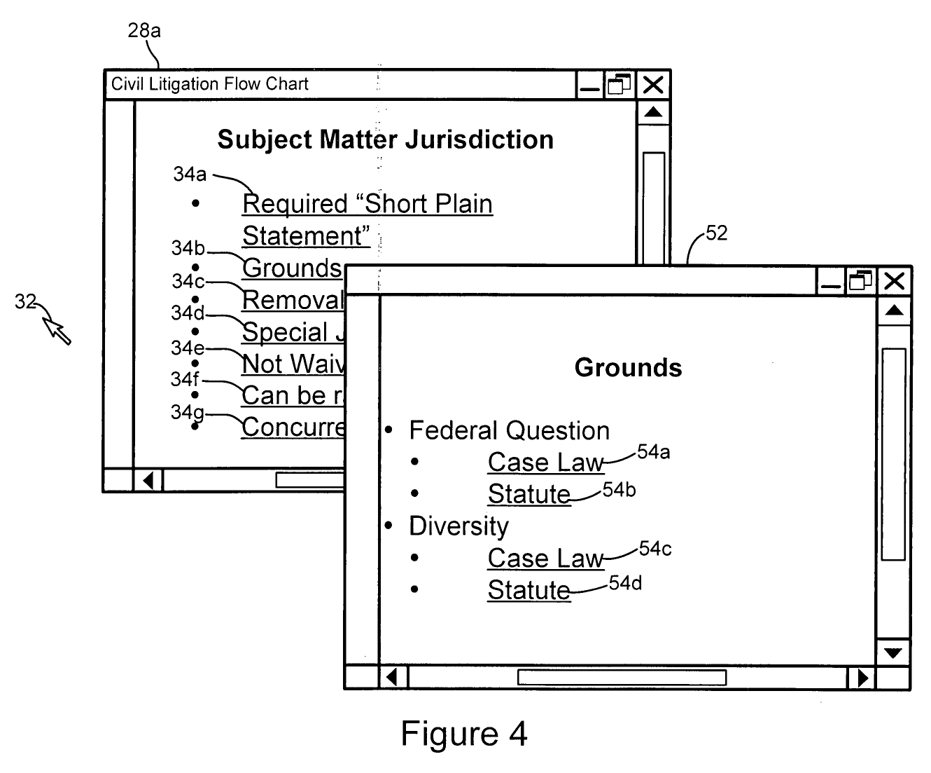

The text strings, such as text string 34b may includes a displayable menu 52, and the menu 52 includes the user selectable link 42. In this example, the end user 12 may navigate the cursor 32 to the text string 34b and then click the text string 34b as depicted in FIG. 4. The menu 52 is embodied in a pop-up window and may further include text strings 54a-d. Menu 52 may also be embodied in a transitionary, temporary, or pop-up window or other graphically defined area that is displayed and contains text strings 54a-d as the user moves the cursor 32 over the text string 34b, but does not click on it. Clicking on the text string 54a for example may initiate the user selectable link 42 for accessing data from selected ones of the online external resources 14, 16, 18.

The online external resources 14, 16, 18, may take the form of computer servers containing databases of content. The online external resources 14, 16, 18 may be operated by private, charitable and governmental entities. The online external resources 14, 16, 18 may be freely accessed (e.g. the GOOGLE! website) or proprietary in nature requiring a fee (e.g. WESTLAW). Access to the online external resources 14, 16, 18 may be via the Internet and through an associated website. In this regard, the user selectable link 42 may be configured to interface with the online external resources 14, 16, 18 via the Internet. The online external resources 14, 16, 18 may be specific database structures within a grouping of databases (for example the WESTLAW “ALLFEDS” database). In the context of the online external resources 14, 16, 18, the term external refers to being separate from a computer device operated or accessed directly by the end user 12. Thus, the research software tool 10 would reside on a computing device remote from a location of the online external resources 14, 16, 18 in terms of physical proximity, security, management or control authority. Thus, the online external resources 14, 16, 18 may be accessed via a website that may be coincidentally co-located with a host computing system as where the research software tool 10 resides.

The user selectable link 42 may be an active link for electronically linking with a given one of the online external resources 14, 16, 18. In this regard, clicking on a given text string may result in retrieval of a specific webpage of a given one of the online external online resources 14, 16, 18. Thus data from discrete or rigid data structures may be retrieved. For example, clicking on the text string 54b “statute” may retrieve a webpage that contains a relevant “statute” related to the topic of “subject matter jurisdiction” based upon “grounds” of a “federal question.” Another example may include the retrieval of the Costa Rican consulate website that allows a user to click on a text string entitled “obtaining visas before travel” in the context of a flowchart related to travel to Costa Rica.

In another arrangement, the user selectable link 42 may be a passive link for electronically linking with selected ones of the online external resource 14, 16, 18. The user selectable link 42 may include predefined search criteria for use with the online external resources 14, 16, 18. In this regard, the user selectable link 42 may include pre-loaded search terms for use in retrieving content contained in the online external resources 14, 16, 18. This may take the form of pre-conditions for access retrieval, parameters such as for a Boolean search, and post-conditions (such as date ranges or particular value types). For example, in the Costa Rican travel flowchart example, a user may select the “obtaining visa before travel” text string and be presented immediately with a list of search results (e.g. a variety of websites relevant to obtaining visas before traveling to Costa Rica) derived from applying the pre-loaded search criteria to an Internet search engine. In this context, an example of a post-condition would be only presenting the user with those results that contain webpages updated within the past year.

In an example configuration, the research software tool 10 includes the flowchart graphic user interface 20 that may be configured to interface with a visual process link 36. The visual process link 36 is programmed to correlate to various ones of the text strings 34a-g that are to be actively linked. Active links refers to a linking process which is non-discrete or non-determinant in nature. The visual process link 36 interfaces with a translation engine 38. The translation engine 38 extracts data from a process link repository 40. The process link repository 40 contains expressions for mapping of VISUAL PROCESS LINK data to UNIFORM PROCESS LINK data. The translation engine 38 interfaces with user selectable link 42 that may take the form of a uniform process link. This step is taken to provide a linguistically normalized expression to the interoperability engine. The user selectable link 42 (which is a uniform process link in this embodiment) interfaces with an interoperability engine interface 44. The interoperability engine interface 44 contains programming which enables the user selectable link 42 to establish a connection with selected ones of the online external resources 14, 16, 18. This would include any necessary computer addressing to navigate to the external resources 14, 16, 18 such as log in ID's and passwords (if necessary) and specifying a data repository within a given one of the online external resources 14, 16, 18. Finally, the research software tool 10 may be configured to establish electronically links 46, 48, 50 to the various external online resources 14, 16, 18. Such links 46, 48, 50 may be established by any of those electrical communications methods which are well known to one of ordinary still in the art.

The user selectable link 42 may be configured to interface with a selected one of the online external resources 14, 16, 18 that may be located and retrieved through a search engine program. Select key words may be pre-loaded and associated with a given one of the defined areas 28a-j (such as the defined areas 28b) and the related text string (such as text sting 34h). For example, clicking on the text string 34b may initiate a search on a search engine utilizing the key terms “grounds,” “subject matter jurisdiction,” and “civil litigation.” Thus, the end user 12 may be able to perform quickly a search.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention.

1-9. (canceled)

10. A research software tool for use with an online external resource, the research software tool comprising:
a flowchart graphic user Interface configured to be displayed on an electronic display, including:
a graphically indicated first defined area,
a text string displayable within the first defined area,
a graphically indicated second defined area,
a text string displayable within the second defined area, at least one of the text strings being user selectable, and
relationship symbology displayable between the first and second defined areas; and
a user selectable link corresponding to at least one of the text strings, the user selectable link being an active link that is configured to interface with the online external resource, and that includes a search criterion related to at least one of the text strings, for use with the online external resource.

11. The research software tool of claim 10 wherein the flowchart graphic user interface illustrates selected steps in a legal process.

12. The research software tool of claim 10 wherein online external resource is a compact disc.

13. The research software tool of claim 10 wherein at least one of the text strings is clickable.

14. The research software tool of claim 10 wherein the search criterion is a Boolean search criterion.

15. The research software tool of claim 10 wherein at least one of the text strings is the user selectable link.

16. The research software tool of claim 10 wherein at least one of the text strings includes a displayable menu, the menu includes the user selectable link.

17. The research software tool of claim 10 wherein the user selectable link is configured to interface with a plurality of online external resources.

18. The research software tool of claim 10 wherein the user selectable link is configured to interface with the online external resource via the internet.

19. The research software tool of claim 10 wherein the user selectable link is configured to provide password information to the online external resource.

20. The research software tool of claim 10 wherein relationship symbology is user-defined.

21. The research software tool of claim 10 wherein the search criterion is related to a legal issue.

22. An apparatus comprising a computer readable memory and program instructions stored in the computer readable memory, wherein the program instructions are configured to:
display a flowchart graphic user interface that includes first and second graphically indicated defined areas;
display a text string within at least one of the first and second graphically indicated defined areas;
display relationship symbology between the first and second graphically indicated defined areas;
provide a user selectable link corresponding to the text string, wherein the user selectable link provides a search criterion to an online external resource; and
display information received from the online external resource in response to a user selecting the user selectable link.

23. The apparatus of claim 22, wherein the first and second graphically Indicated defined areas represent selected steps of a legal process.

24. The apparatus of claim 22, wherein the program instructions are further configured to print the flowchart graphic user interface.

25. The apparatus of claim 22, wherein the text string is clickable.

26. The apparatus of claim 22, wherein the search criterion is a Boolean search criterion.

27. The apparatus of claim 22, wherein the text string is the user selectable link.

28. The apparatus of claim 22, wherein the text string includes a displayable menu, the menu including the user selectable link.

29. The apparatus of claim 22, wherein the user selectable link is configured to interface with a plurality of online external resources.

30. The apparatus of claim 22, wherein the user selectable link is configured to interface with the online external resource via the Internet.

31. The apparatus of claim 22, wherein the user selectable link is configured to provide password information to the online external resource.

32. The apparatus of claim 22, wherein the relationship symbology is user-defined.

33. The apparatus of claim 22, wherein the relationship symbology indicates a sequence with respect to actions corresponding to the first and second graphically indicated defined areas.
